(19) United States
(12) Patent Application Publication
(10) Pub. No.: US 2016/0167218 A1
(43) Pub. Date: Jun. 16, 2016

(54) HEXAGONAL WRENCHES HOLDER

(71) Applicant: Chin-Ying Chou, Taichung City (TW)

(72) Inventor: Chin-Ying Chou, Taichung City (TW)

(21) Appl. No.: 14/565,426

(22) Filed: Dec. 10, 2014

(51) Int. Cl. B25H 3/00; B25B 15/00

(52) U.S. Cl. CPC B25H 3/003; B25B 15/008

(57) ABSTRACT

A hexagonal wrenches holder includes a main board with a thickness, and multiple first passages defined through the top and the bottom of the main board. The main board has a groove in one side thereof, and a window is defined through the main board and communicates with the groove and the first passages. Each of the first passages has a sleeve inserted therein and each sleeve has a first hole so that a hexagonal wrench is inserted into the first hole. The sleeves each have a first toothed ring mounted to the outside thereof. A slide is slidably engaged with the groove and has driving teeth which are engaged with the first toothed rings of the sleeves via the window. The hexagonal wrenches are rotated when moving the slide.

### BACKGROUND OF THE INVENTION

1. Fields of the Invention

The present invention relates to a wrench holder, and more particularly, to a hexagonal wrenches holder with an easy operation device to rotate the wrenches for convenience of pulling wrenches from the holder.

2. Descriptions of Related Art

The conventional way for carry tools is to use a tool box in which multiple tools are received. However, the tool box with the tools are heavy and difficult to carry or move between work sites, so that the workers usually carry the tools that are used frequently. These tools are put in a pocket or inserted into the pockets of a belt. Nevertheless, the number of the tools is limited and may not meet the practical needs.

A tool holder is developed and includes two holding portions which are connected to the main part of the holder by two pivotal units. The two holding portions can be expanded relative to the pivotal units so that the tools are visible and can be picked out from the holding portions. However, these tools such as the L-shaped hexagonal wrenches are overlapped with each other at one end thereof, so that the user has to remove some of the wrenches to pick the wrench with the specific size. This takes a lot of time.

The present invention intends to provide a hexagonal wrenches holder which eliminates the shortcomings mentioned above.

### SUMMARY OF THE INVENTION

The present invention relates to a hexagonal wrenches holder and comprises a main board with a thickness and the main board has multiple first passages defined through the top and the bottom of the main board. A groove is defined in the first side of the main board, and a window is defined through the main board and communicates with the groove and the first passages. Each of the first passages has a sleeve inserted therein. A first hole is defined axially through each of the sleeves and a hexagonal wrench is inserted into the first hole. The sleeves each have a first toothed ring mounted to the outside thereof. Each of the first toothed rings is located corresponding to the window. A slide is slidably engaged with the groove and has driving teeth which are located to be engaged with the first toothed rings of the sleeves. When the slide is moved, the first toothed rings are driven to rotate the hexagonal wrenches.

Preferably, the sleeves have the same diameter. The first holes of the sleeves are different from each other for receiving the hexagonal wrenches of different sizes. The slide has an extension extending an angle from one of two ends thereof.

Preferably, the first toothed rings on the sleeves are located alternatively in a vertical direction.

Preferably, the first toothed rings on the sleeves are located along a horizontal line.

Preferably, the groove of the board has two openings defined in two ends thereof. A secondary board is located on the first side of the main board. Multiple second passages are defined through the top and the bottom of the secondary board. The secondary board has a communication hole defined in the first side thereof, and the communication hole communicates with the second passages. The second passages each have a positioning member received therein. Each positioning member has a second hole defined axially therethrough. Each positioning member has a second toothed ring mounted to the outside thereof. The second toothed rings are located corresponding to the communication hole. The slide has a toothed face which are engaged with the second toothed rings. A U-shaped control member is located on the second side of the secondary board. The two ends of the U-shaped control member are slidably engaged with the groove via the two openings.

Preferably, the two openings are dovetail-shaped openings, and the two ends of the U-shaped control member each are a dovetail-shaped end. The U-shaped control member and the secondary board are integrally formed with each other or are two individual parts. A resilient member is biased between one end of the slide and one of the two ends of the U-shaped control member.

Alternatively, the present invention provides a hexagonal wrenches holder and comprises a main board with a thickness and the main board has multiple first passages defined through the top and the bottom thereof. A groove is defined in the first side of the main board. A window is defined through the main board and communicates with the groove and the first passages. Each of the first passages has a sleeve inserted therein. A first hole is defined axially through each of the sleeves and so as to accommodate a hexagonal wrench therein. The sleeves each have a first toothed ring mounted to the outside thereof. Each of the first toothed rings is located corresponding to the window. A secondary board is located on the first side of the main board. Multiple second passages are defined through the top and the bottom of the secondary board. The secondary board has a communication hole defined in the first side thereof, and the communication hole communicates with the second passages. The second passages each have a positioning member received therein. Each positioning member has a second hole defined axially therethrough and has a second toothed ring mounted to the outside thereof. A slide is slidably engaged with the groove and has driving teeth defined in the first side thereof. The driving teeth are located to be engaged with the first toothed rings of the sleeves. The slide has a toothed face defined in the second side thereof and the toothed face is engaged with the second toothed rings. The slide is movably located between the secondary board and the main board to rotate the sleeves and the positioning members. An end of the slide is exposed beyond the secondary board and the main board. When the slide is pulled by pulling the end of the slide, the first and second toothed rings, 52 are rotated.

Preferably, the U-shaped control member and the secondary board are integrally formed with each other.

Preferably, the first toothed rings on the sleeves are located alternatively in a vertical direction, or the first toothed rings on the sleeves are located along a horizontal line.

Preferably, the second toothed rings on the positioning members are located alternatively in a vertical direction, or the second toothed rings on the positioning members are located along a horizontal line.

The primary object of the present invention is to provide a hexagonal wrenches holder which has a slide and the user moves the slide to rotate the wrenches an angle so as to be easily pick the desired wrench.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hexagonal wrenches holder of the present invention;

FIG. 2 is a perspective view to show the second embodiment of the hexagonal wrenches holder of the present invention;

FIG. 3 is a perspective view to show the third embodiment of the hexagonal wrenches holder of the present invention;

FIG. 4 is an exploded view of the third embodiment of the hexagonal wrenches holder of the present invention;

FIG. 5 shows that the hexagonal wrenches of the third embodiment of the hexagonal wrenches holder of the present invention are not yet rotated;

FIG. 6 shows that the secondary board of the third embodiment of the hexagonal wrenches holder of the present invention is moved toward left and the hexagonal wrenches of the secondary board are rotated;

FIG. 7 shows that the secondary board of the third embodiment of the hexagonal wrenches holder of the present invention in FIG. 6 returns and the hexagonal wrenches of the secondary board are rotated back to their original positions;

FIG. 8 shows that the secondary board of the third embodiment of the hexagonal wrenches holder of the present invention moves toward right;

FIG. 9 shows the top view of the fourth embodiment of the hexagonal wrenches holder of the present invention;

FIG. 10 shows that the hexagonal wrenches in FIG. 6 are rotated, and

FIG. 11 shows that the slide has an extension extending from one end thereof.

### DETAILED DESCRIPTION OF THE PREFERRED EMBODIMENT

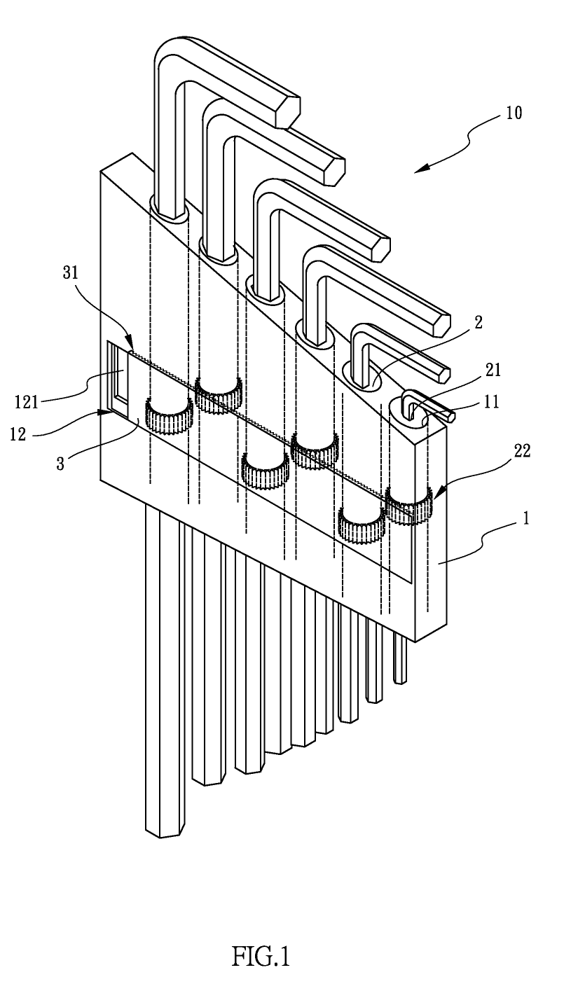

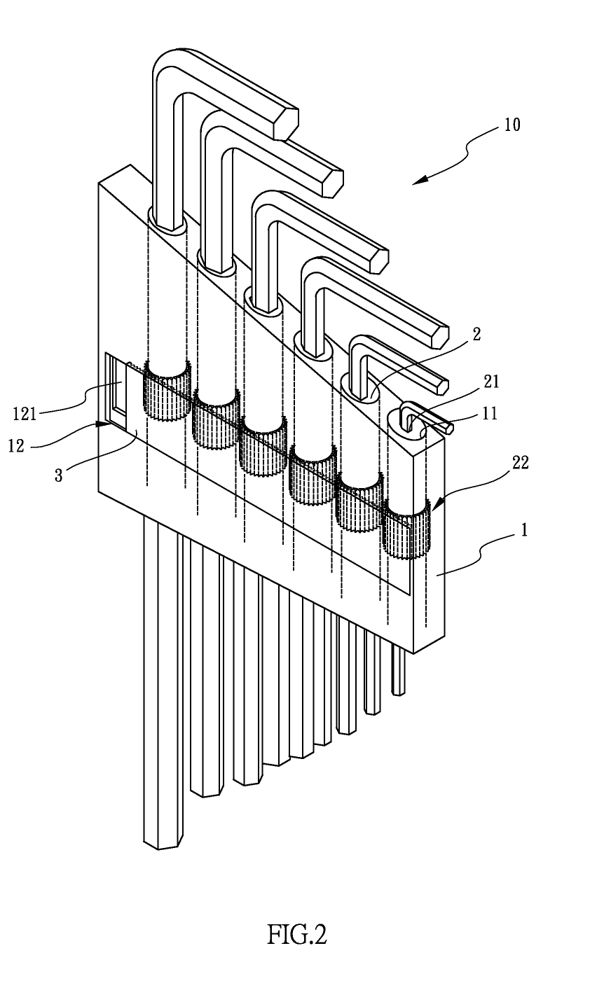

Referring to FIGS. 1 and 2, the hexagonal wrenches holder of the present invention comprises a main board 1 with a certain thickness and the main board 1 has multiple first passages 11 defined through the top and the bottom of the main board 1. A groove 12 is defined in the first side of the main board 1, and a window 121 is defined through the main board 1 and communicates with the groove 12 and the first passages 11. Each of the first passages 11 has a sleeve 2 inserted therein. A first hole 21 is defined axially through each of the sleeves 2 and a hexagonal wrench 10 is inserted into the first hole 21. The sleeves 2 have the same diameter. The first holes 21 of the sleeves 2 are different from each other for receiving the hexagonal wrenches of different sizes. The sleeves 2 each have a first toothed ring 22 mounted to the outside thereof. Each of the first toothed rings 2 is located corresponding to the window 121.

A slide 3 is slidably engaged with the groove 12 and has driving teeth 31 which are located to be engaged with the first toothed rings 22 of the sleeves 2. The first toothed rings 22 on the sleeves 2 are located alternatively in a vertical direction as shown in FIG. 1, or the first toothed rings 22 on the sleeves 2 are located along a horizontal line as shown in the second embodiment shown in FIG. 2. When the slide 3 is moved, the first toothed rings 22 are driven to rotate the hexagonal wrenches 10.

When the slide 3 is not moved, the hexagonal wrenches are located on the plane that the main board 1 is located, and when the slide 3 is moved, the hexagonal wrenches are rotated an angle so that the user can easily pick any one of the hexagonal wrenches.

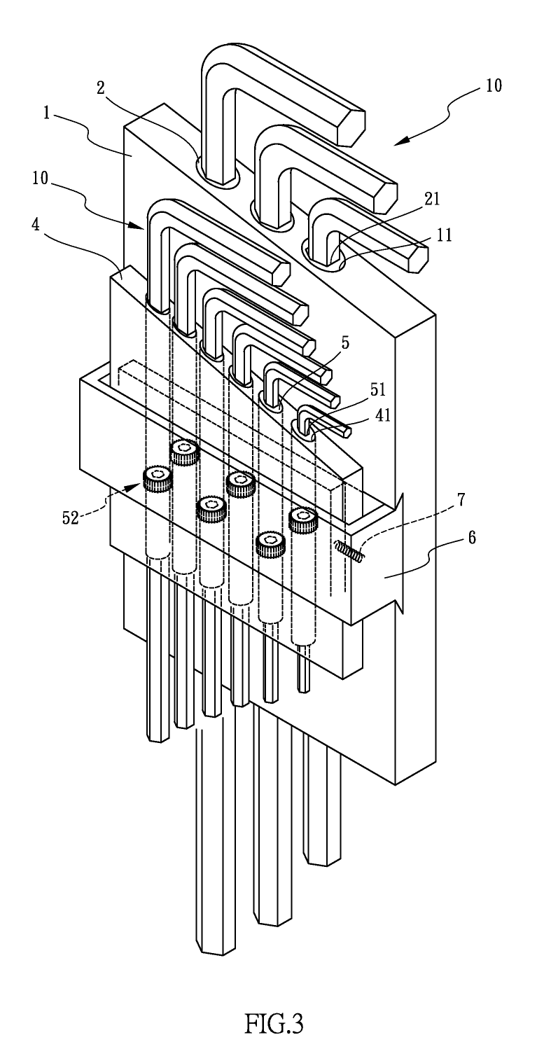

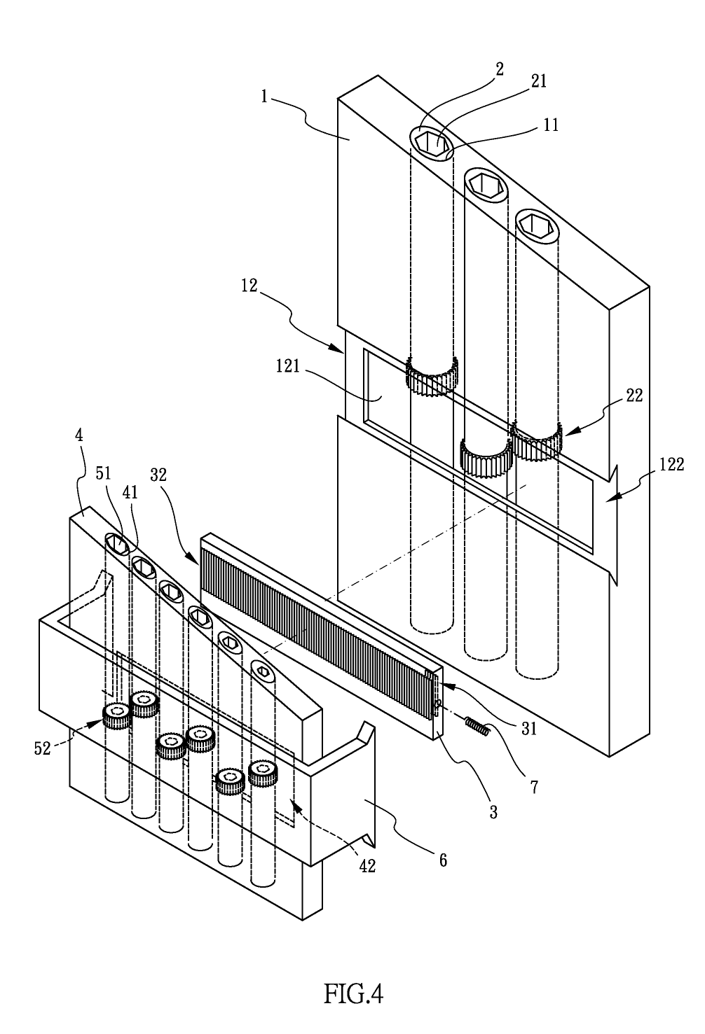

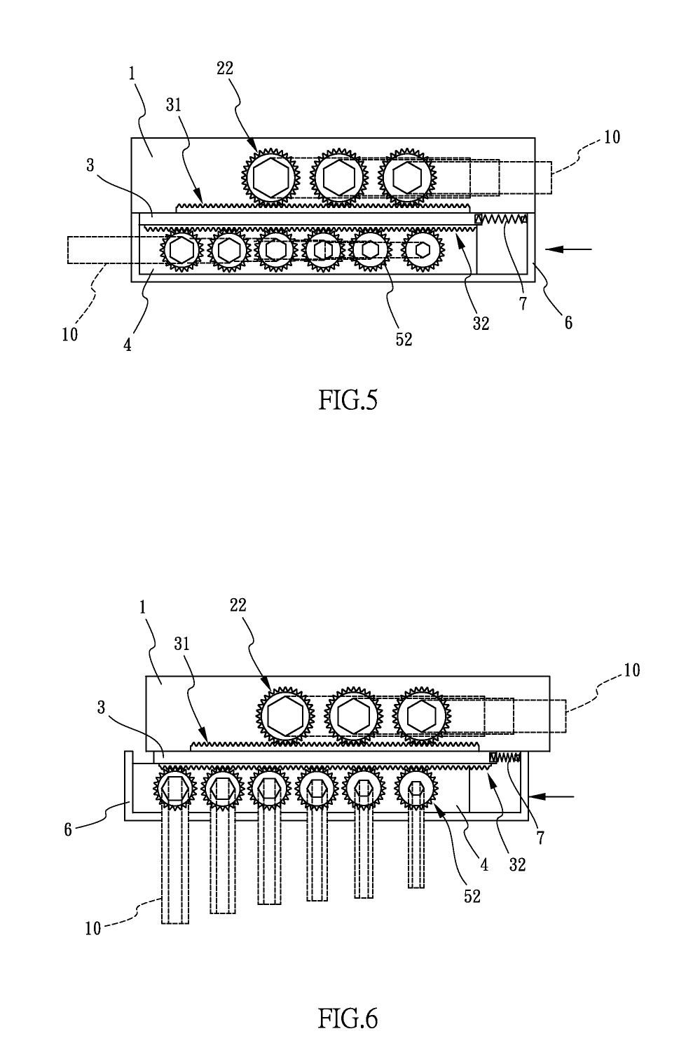

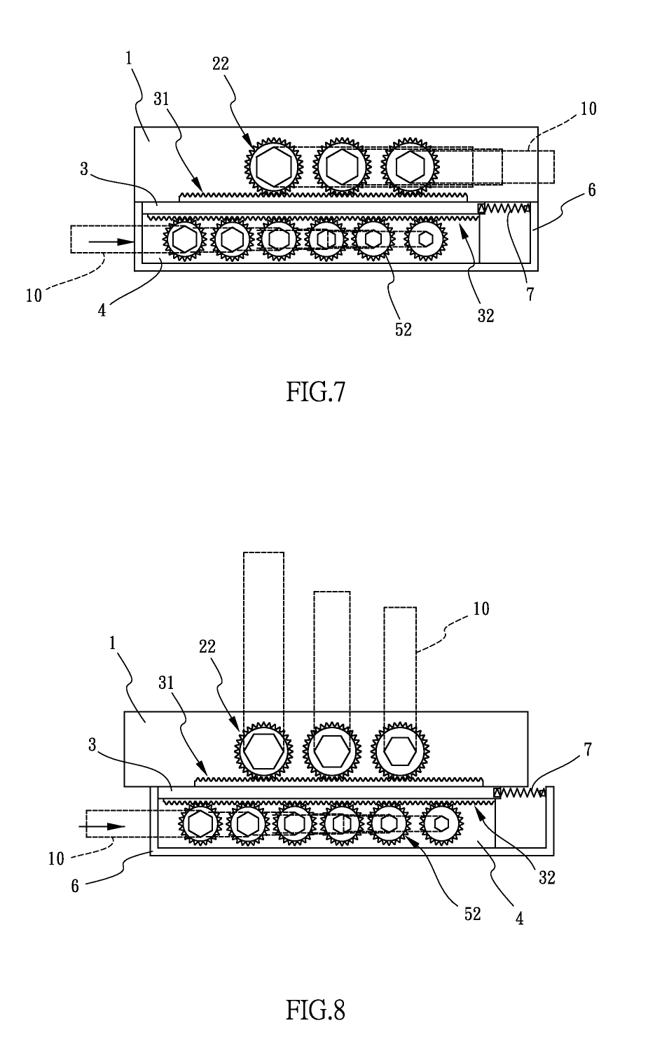

As shown in FIGS. 3-8 and the third embodiment is disclosed, wherein the groove 12 of the board 2 has two openings 122 defined in two ends thereof. A secondary board 4 is located on the first side of the main board 1, and multiple second passages 41 are defined through the top and the bottom of the secondary board 4. The secondary board 4 has a communication hole 42 defined in the first side thereof, and the communication hole 42 communicates with the second passages 41. The second passages 41 each have a positioning member 5 received therein. Each positioning member 5 has a second hole 51 defined axially therethrough. Again, the second holes 51 may have different sizes to receive the hexagonal wrenches of different sizes. Each positioning member 5 has a second toothed ring 52 mounted to the outside thereof. The second toothed rings 52 are located corresponding to the communication hole 42. The slide 3 has a toothed face 32 which are engaged with the second toothed rings 52.

A U-shaped control member 6 is located on the second side of the secondary board 4. The two ends of the U-shaped control member 6 are slidably engaged with the groove 12 via the two openings 122. Preferably, the two openings 122 are dovetail-shaped openings, and the two ends of the U-shaped control member 6 each are a dovetail-shaped end. A resilient member 7 is biased between one end of the slide 3 and one of the two ends of the U-shaped control member 6. The resilient member 7 provides a force to return the control member 6 and the secondary board 4. The U-shaped control member 6 and the secondary board 4 are integrally formed with each other or are two individual parts.

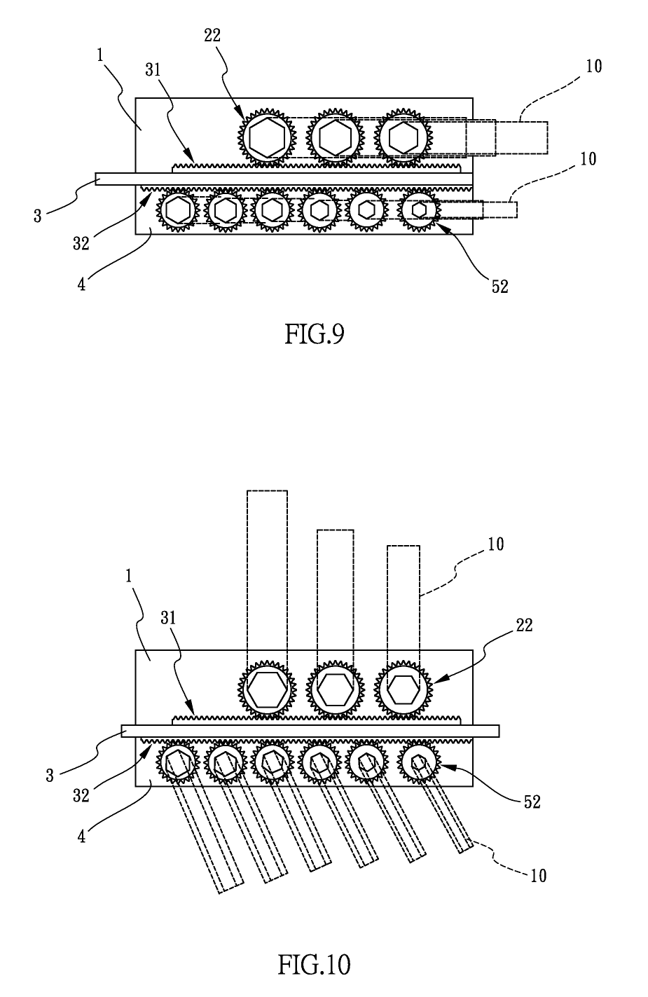

As shown in FIGS. 9 and 10, a fourth embodiment is disclosed, wherein the third embodiment uses the control member 6 to rotate the hexagonal wrenches, but the fourth embodiment uses the slide 3 to control the rotation of the hexagonal wrenches. The slide 3 is movably located between the secondary board 4 and the main board 1 to rotate the sleeves 2 and the positioning members 5. An end of the slide 3 is exposed beyond the secondary board 4 and the main board 1. When the slide 3 is pulled by pulling the end of the slide 3, the first and second toothed rings 22, 52 are rotated. In the fourth embodiment, the secondary board 4 and the main board 1 are integral formed with each other.

The first toothed rings 22 on the sleeves 2 are located alternatively in a vertical direction, or the first toothed rings 22 on the sleeves 2 are located along a horizontal line. The second toothed rings 52 on the positioning members 5 are located alternatively in a vertical direction, or the second toothed rings 52 on the positioning members 5 are located along a horizontal line.

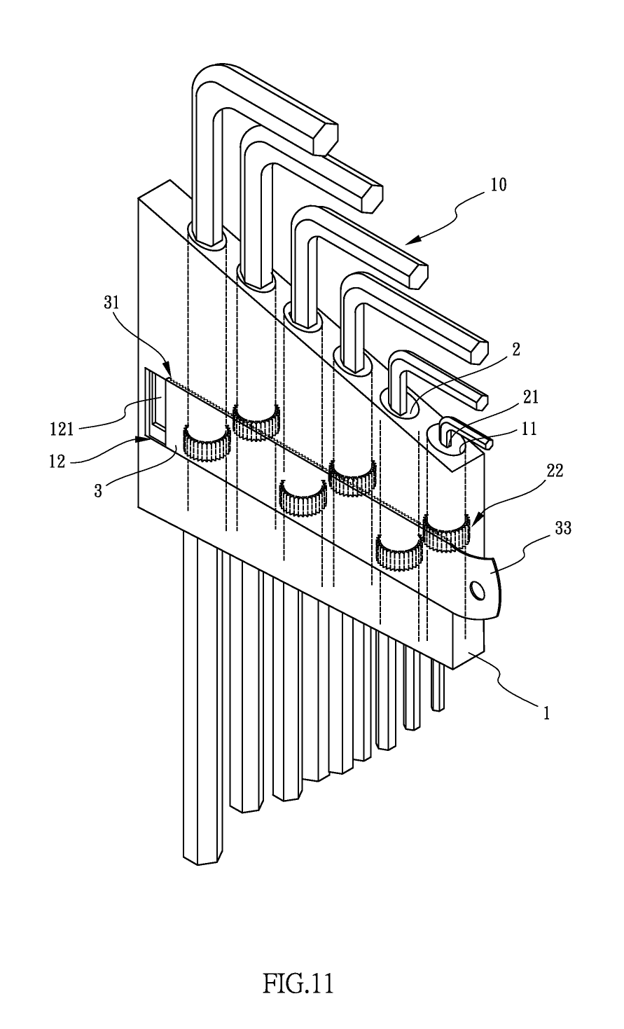

As shown in FIG. 11, the slide 3 has an extension 33 extending an angle from one of two ends thereof. The user is clearly acknowledged where to hold and operate the slide 3.

While we have shown and described the embodiment in accordance with the present invention, it should be clear to those skilled in the art that further embodiments may be made without departing from the scope of the present invention.

What is claimed is:

1. A hexagonal wrenches holder comprising:
a main board (1) with a thickness and having multiple first passages (11) defined through a top and a bottom of the main board (1), a groove (12) defined in a first side of the main board (1), a window (121) defined through the main board (1) and communicating with the groove (12) and the first passages (11), each of the first passages (11) having a sleeve (2) inserted therein, a first hole (21) defined axially through each of the sleeves (2) and being adapted to accommodate a hexagonal wrench (10) which is inserted into the first hole (21), the sleeves (2) each having a first toothed ring (22) mounted to an outside thereof, each of the first toothed rings (2) located corresponding to the window (121), and
a slide (3) slidably engaged with the groove (12) and having driving teeth (31) which are located to be engaged with the first toothed rings (22) of the sleeves (2), when the slide (3) is moved, the first toothed rings (22) are driven to rotate the hexagonal wrenches (10).

2. The holder as claimed in claim 1, wherein the sleeves (2) have the same diameter, the first holes (21) of the sleeves (2) are different from each other for receiving the hexagonal wrenches of different sizes, the slide (3) has an extension (33) extending an angle from one of two ends thereof.

3. The holder as claimed in claim 1, wherein the first toothed rings (22) on the sleeves (2) are located alternatively in a vertical direction.

4. The holder as claimed in claim 1, wherein the first toothed rings (22) on the sleeves (2) are located along a horizontal line.

5. The holder as claimed in claim 1, wherein the groove (12) of the board (2) has two openings (122) defined in two ends thereof, a secondary board (4) is located on the first side of the main board (1), multiple second passages (41) defined through a top and a bottom of the secondary board (4), the secondary board (4) has a communication hole (42) defined in a first side thereof, the communication hole (42) communicates with the second passages (41), the second passages (41) each have a positioning member (5) received therein, each positioning member (5) has a second hole (51) defined axially therethrough, each positioning member (5) has a second toothed ring (52) mounted to an outside thereof, the second toothed rings (52) are located corresponding to the communication hole (42), the slide (3) has a toothed face (32) which are engaged with the second toothed rings (52), a U-shaped control member (6) is located on a second side of the secondary board (4), the two ends of the U-shaped control member (6) are slidably engaged with the groove (12) via the two openings (122).

6. The holder as claimed in claim 5, wherein the two openings (122) are dovetail-shaped openings, the two ends of the U-shaped control member (6) each are a dovetail-shaped end, the U-shaped control member (6) and the secondary board (4) are integrally formed with each other or are two individual parts, a resilient member (7) is biased between one end of the slide (3) and one of the two ends of the U-shaped control member (6).

7. A hexagonal wrenches holder comprising:
a main board (1) with a thickness and having multiple first passages (11) defined through a top and a bottom of the main board (1), a groove (12) defined in a first side of the main board (1), a window (121) defined through the main board (1) and communicating with the groove (12) and the first passages (11), each of the first passages (11) having a sleeve (2) inserted therein, a first hole (21) defined axially through each of the sleeves (2) and being adapted to accommodate a hexagonal wrench (10) is inserted into the first hole (21), the sleeves (2) each having a first toothed ring (22) mounted to an outside thereof, each of the first toothed rings (2) located corresponding to the window (121);
a secondary board (4) located on the first side of the main board (1), multiple second passages (41) defined through a top and a bottom of the secondary board (4), the secondary board (4) having a communication hole (42) defined in a first side thereof, the communication hole (42) communicating with the second passages (41), the second passages (41) each having a positioning member (5) received therein, each positioning member (5) having a second hole (51) defined axially therethrough, each positioning member (5) having a second toothed ring (52) mounted to an outside thereof, and
a slide (3) slidably engaged with the groove (12) and having driving teeth (31) defined in a first side thereof, the driving teeth (31) located to be engaged with the first toothed rings (22) of the sleeves (2), the slide (3) having a toothed face (32) defined in a second side thereof and the toothed face (32) engaged with the second toothed rings (52), the slide (3) movably located between the secondary board (4) and the main board (1) to rotate the sleeves (2) and the positioning members (5), an end of the slide (3) being exposed beyond the secondary board (4) and the main board (1), when the slide (3) is pulled by pulling the end of the slide (3), the first and second toothed rings (22, 52) are rotated.

8. The holder as claimed in claim 7, wherein the U-shaped control member (6) and the secondary board (4) are integrally formed with each other.

9. The holder as claimed in claim 7, wherein the first toothed rings (22) on the sleeves (2) are located alternatively in a vertical direction, or the first toothed rings (22) on the sleeves (2) are located along a horizontal line.

10. The holder as claimed in claim 9, wherein the second toothed rings (52) on the positioning members (5) are located alternatively in a vertical direction, or the second toothed rings (52) on the positioning members (5) are located along a horizontal line.
